(19) United States
(12) Patent Application Publication
(10) Pub. No.: US 2009/0150004 A1
(43) Pub. Date: Jun. 11, 2009

(54) WIRELESS BUILDING AUTOMATION AND CONTROL NETWORK

(75) Inventors: Ling Wang, Chicago, IL (US); Kent E. Crouse, Carpentersville, IL (US); George L. Grouev, Arlington Heights, IL (US); William L. Keith, Lake In The Hills, IL (US); Russell L. Powers, Woodridge, IL (US); Andrew C. Brown, Carpentersville, IL (US); James Cai, Burr Ridge, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/066,413

(22) PCT Filed: Sep. 27, 2006
(86) PCT No.: PCT/IB06/53518

§ 371 Date: Mar. 11, 2008

Related U.S. Application Data
(60) Provisional application No. 60/722,670, filed on Sep. 30, 2005.

(51) Int. Cl. G06F 1/28; G06F 17/00; G06N 5/02

(52) U.S. Cl. 700/286; 700/90; 706/46

(57) ABSTRACT

A network (20) employs a wireless network topology (30), a wireless network manager (40). Network (20) further employs a wireless device (70) and wireless device manager (80) pairing and/or a wireless system (90) and a wireless system manager (100) pairing. Managers (40, 80) cooperatively control an operating profile and monitor an operational status of the device (70). Managers (40, 100) cooperatively control an operating profile and monitor an operational status of system (90). Manager (40) can be installed on a computer (150, 170) and wirelessly communicate within network (20) via a wireless control device (160, 180) employing a port connector (161, 181) that can be plugged into a port (151, 171) of the computer (150, 170). Device (70) or system (90) can implement a digital ballast (120) that determines an average power consumption of the digital ballast (120) drawn by a power interface (121) of digital ballast (120).

The present invention relates to wireless network for controlling lighting devices/systems, HVAC devices/systems, and other building access and management devices and systems (e.g., fire detection, security and elevators) in a commercial institutional building or a residential home. The present invention further relates to improving the functionality of ballasts, particularly ones that can be incorporated into a wireless network, and to providing a wireless control device that can be plugged into a computer (e.g., a personal computer, a workstation, a personal data assistance, a server, etc.) to facilitate an incorporation of the computer into a wireless network.

Building and homes traditionally have lighting devices/systems, HVAC devices/systems and other management devices/systems separately controlled and most of them are manual. Furthermore, information of each device/system, such as, for example, a power consumption of a lighting system or a temperature in a room, is not readily available to the building owners and facility managers.

Additionally, ballasts traditionally have only had the capability to switch one or more lights sources between an ON state and an OFF state with a dimming function when the light source(s) are switched on.

Furthermore, lighting control devices (e.g., a wall switch, a wall dimmer and a infrared remote control) typically do not facilitate a technique for incorporating a computer into a wireless network, particularly a technique that converts commands from the computer to wireless signals for controlling the wireless network.

The present invention addresses this drawbacks by providing a new and unique inventions in the form of a wireless building automation and control network incorporating wireless managers, an intelligent ballast and a wireless control device.

In a first form of the present invention, a wireless building and automation control network employs a wireless network topology, a wireless network manager, a wireless device, and a wireless device manager operable to be in wireless communication with the wireless network manager in accordance with a communication protocol of the wireless network topology. The wireless network manager and the wireless device manager are cooperatively operable to control an operating profile and to monitor an operational status of the wireless device.

In a second form of the present invention, a wireless building and automation control network employs a wireless network topology, a wireless network manager, a wireless system, and a wireless system manager operable to be in wireless communication with the wireless network manager in accordance with a communication protocol of the wireless network topology. The wireless network manager and the wireless system manager are cooperatively operable to control an operating profile and to monitor an operational status of the wireless system.

In a third form of the present invention, a digital ballast employs a ballast controller and a power interface operable electrically communicate a root means square voltage (V_{RMS}) and a roots means square current (I_{RMS}) to the ballast controller. The root means square voltage (V_{RMS}) and the roots means square current (I_{RMS}) are indicative of a power output of the power interface, and the ballast controller is operable to determine an average power consumption of the digital ballast as a product of the root means square voltage (V_{RMS}) and the roots means square current (I_{RMS}).

In a fourth form of the present invention, a wireless control device, employs a controller operable to perform data and signal transfers with a computer, and to perform data and signal transfers with a wireless network node, a transceiver operable to establish a wireless communication between the controller and the wireless network node, a port connector operable to plug the wireless control device into a port of a computer, and a data/signal converter operable to convert data and signal transfers between the controller and the computer via the port connector and the port.

The foregoing forms and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

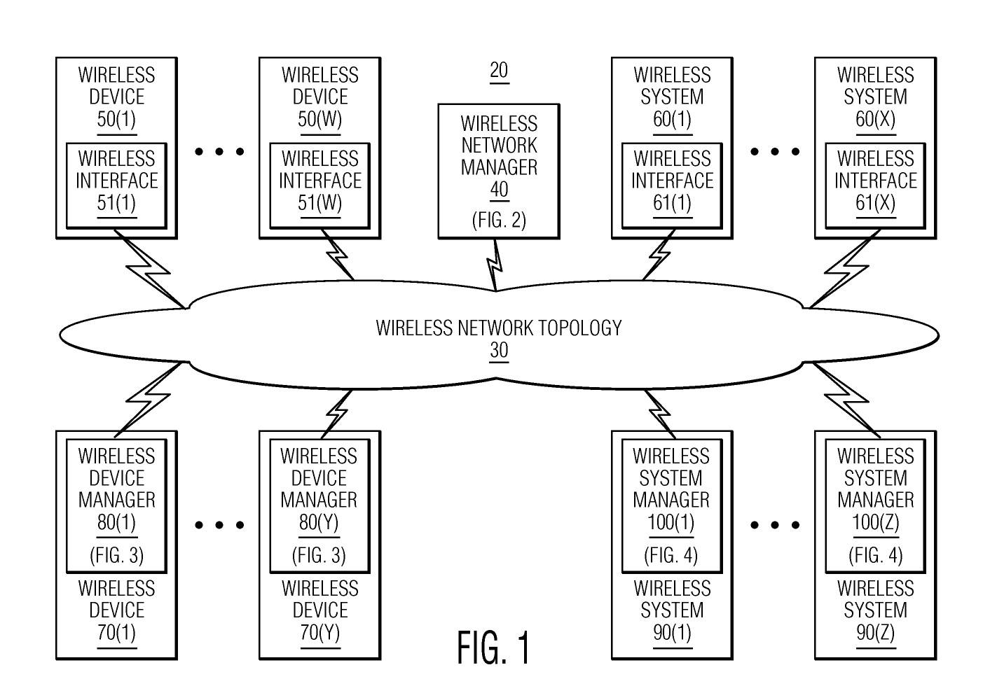

FIG. 1 illustrates one embodiment of a wireless building automation and control network in accordance with the present invention;

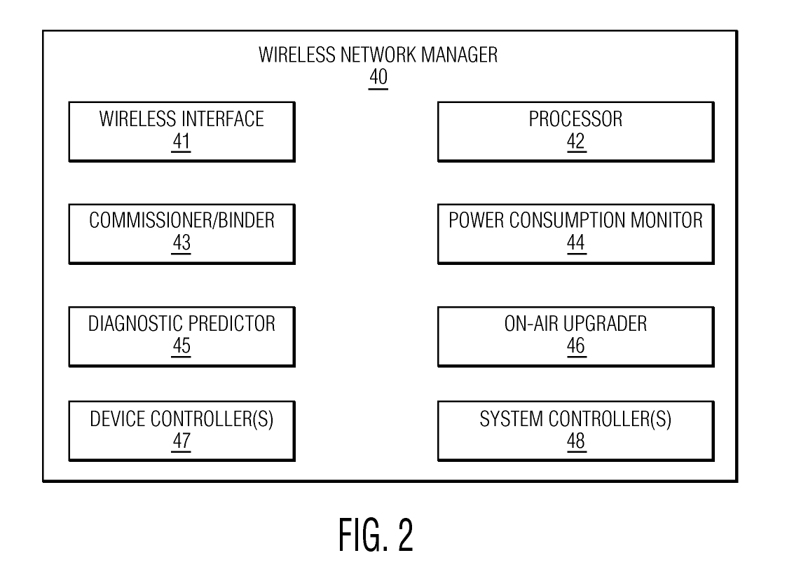

FIG. 2 illustrates one embodiment of a wireless network manager in accordance with the present invention;

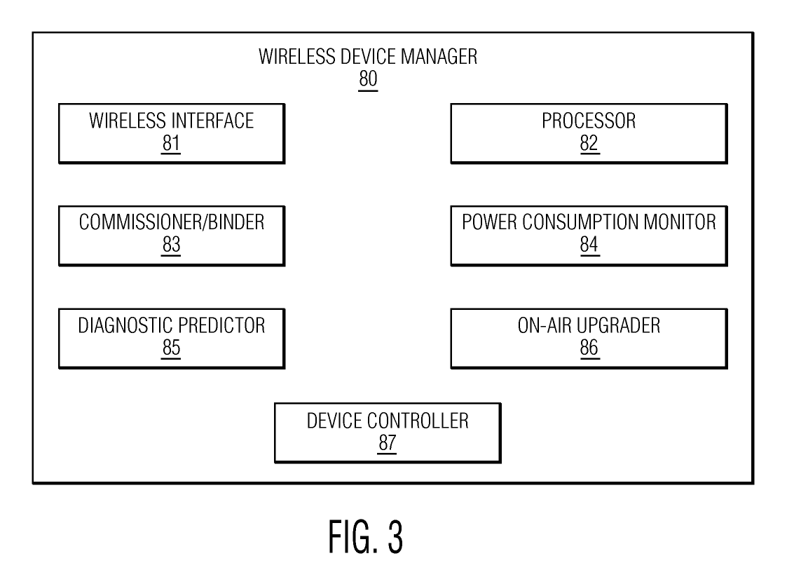

FIG. 3 illustrates one embodiment of a wireless device manager in accordance with the present invention;

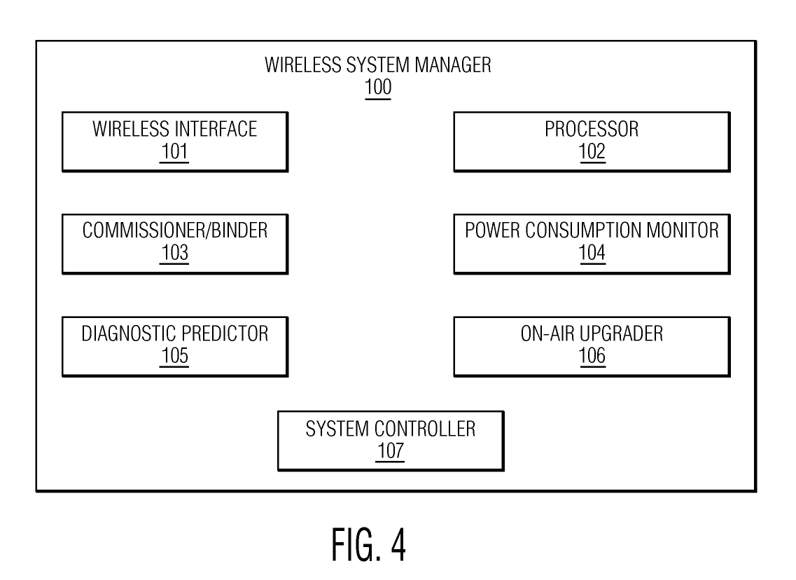

FIG. 4 illustrates one embodiment of a wireless system manager in accordance with the present invention;

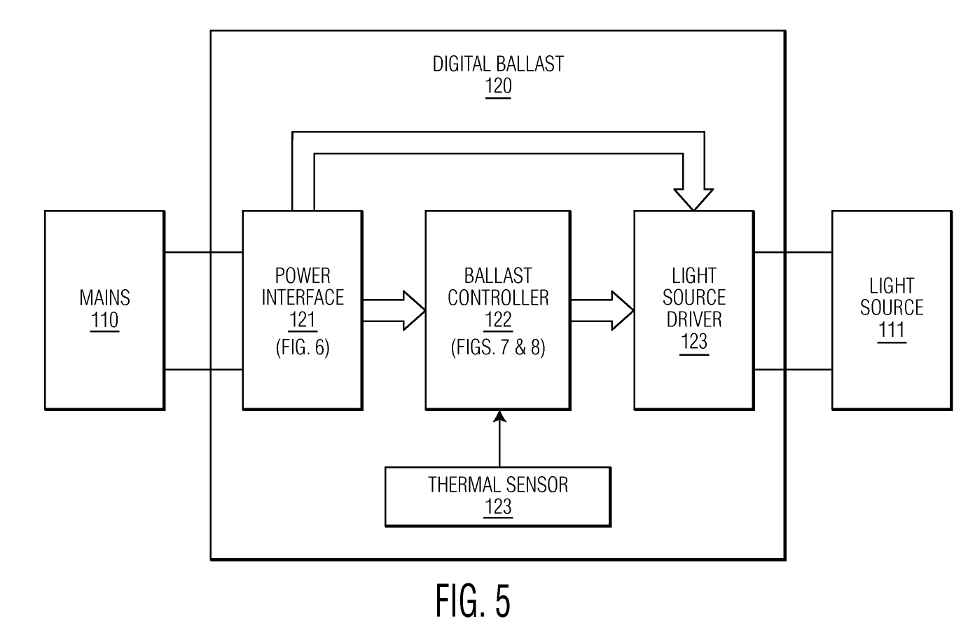

FIG. 5 illustrates one embodiment of an intelligent ballast in accordance with the present invention;

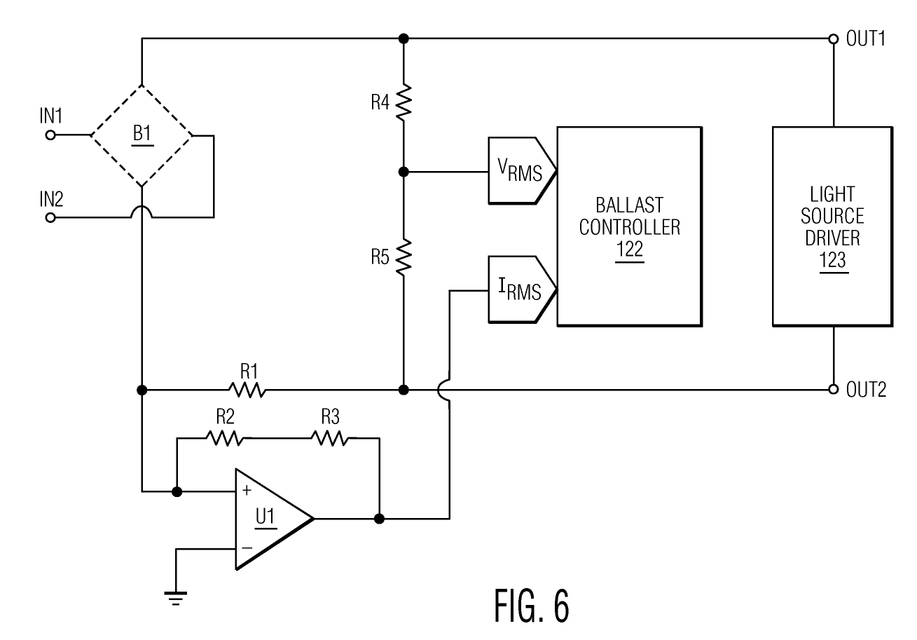

FIG. 6 illustrates one embodiment of a power measurement unit in accordance with the present invention;

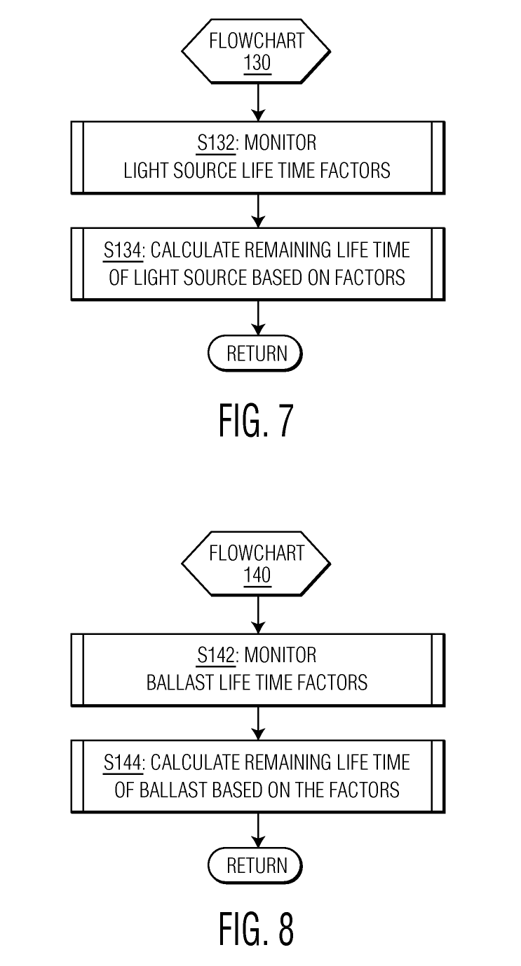

FIG. 7 illustrates a flowchart illustrative of one embodiment of a light source life time prediction method of the present invention;

FIG. 8 illustrates a flowchart illustrative of one embodiment of a ballast life time prediction method of the present invention;

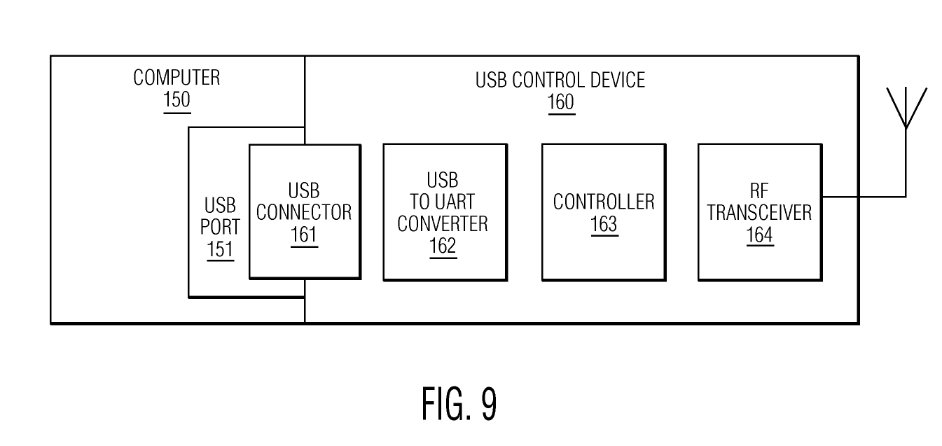

FIG. 9 illustrates a first embodiment of the wireless lighting control device in accordance with the present invention; and

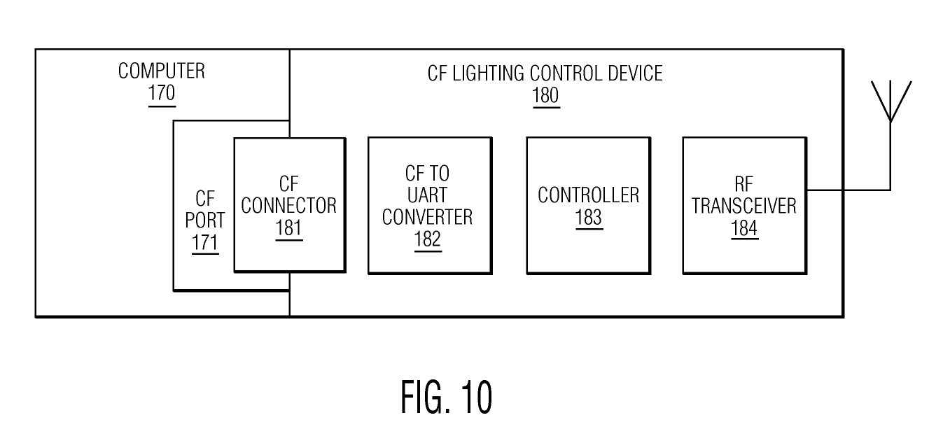

FIG. 10 illustrates a second embodiment of the wireless lighting control device in accordance with the present invention

A wireless building and automation control network 20 as illustrated in FIG. 1 employs a wireless network topology 30 of any type (e.g., a star topology, a mesh topology, a cluster tree topology or any combination thereof) facilitating wireless communication between various wireless network nodes in the form of a wireless network manager 40, up to W number of wireless devices 50, up to X number of wireless systems 60, up to Y number of wireless devices 70 with each wireless device 70 having a wireless device manager 80, and up to Z number of wireless systems 90 with each wireless system 90 having a wireless system manager 100. For network 20, W≧0, X≧0, Y≧0, Z≧0 and (W+X+Y+Z)≧1.

A wireless communication between two wireless network nodes 40-70 and 90 is either direct (i.e., one hop) or routed (i.e., multi-hop) in accordance with a wireless communication protocol (e.g., ZigBee) implemented for the particular configuration of wireless network topology 30.

Wireless network manager 40 is structurally configured with hardware, software and/or any combination thereof to directly manage wireless device(s) 50 and wireless system(s) 60, to indirectly manage each wireless device 70 being directly managed by a corresponding wireless device manager 80, and to indirectly manage each wireless system 90 being directly managed by a corresponding wireless system manager 100. Wireless network manager 40 can be implemented on any platform (e.g., a server, a workstation, a personal computer, etc.).

In practice, the structural configuration of wireless network manager 40 is dependent upon its commercial implementation. Therefore, the present invention does not impose any limitations or any restrictions as to the structural configuration of wireless network manager 40 other than the ability to wirelessly interface with the other nodes of network 20 via wireless network topology 30. Thus, the following description of one embodiment of wireless network manager 40 as illustrated in FIG. 2 does not limit or restrict the structural configuration of wireless network manager 40.

Referring to FIG. 2, the illustrated embodiment of wireless network manager 40 includes a wireless interface 41, a processor 42, a commissioner/binder 43, a power consumption monitor 44, a diagnostic predictor 45, an on-air upgrader 46, up to W+Y device controllers 47, and up to X+Z system controllers 48. Wireless interface 41 is structurally configured to facilitate a wireless interfacing of processor 42 with wireless network topology 30 (FIG. 1) in accordance with a wireless communication protocol (e.g., ZigBee). In one embodiment, wireless interface 41 is a wireless control device as will further described herein in connection with FIGS. 9 and 10.

Commissioner/binder 43 is structurally configured with hardware, software and any combination thereof to facilitate an implementation by processor 42 of a commissioning and binding of each network node 50, 60, 70 and 90. For example, upon a physical installation of each network node 50, 60, 70 and 90 in a building or home, processor 42 implements commissioner/binder 43 to facilitate a joining of network 20 by each network node 50, 60, 70 and 90 and to facilitate one or more functional groupings of network nodes 50, 60, 70 and 90 as desired.

Power consumption monitor 44 is structurally configured with hardware, software or a combination thereof to facilitate a reception by processor 42 of information from each network nodes 50, 60, 70 and 90 related to power consumption measurements performed by each network node 50, 60, 70 and 90. This enables processor 42 to determine an overall energy consumption by network 20 whereby processor 42 can use an average power consumption breakdown by time of day, floor numbers or some other distinction that allows processor 42 to manage power consumption levels by the other network nodes in a manner directed to avoiding unnecessary energy consumption.

Diagnostic predictor 45 is structurally configured with hardware, software or a combination thereof to facilitate a reception by processor 42 of information from each network node 50, 60, 70 and 90 related to a maintenance and predicted end of life of that node. This enables processor 42 to provide an indication (e.g., an alarm) indicative of a maintenance parameter and/or an end of life prediction parameter being in nonconformance with certain criteria for such parameters.

On-air upgrader 46 is structurally configured with hardware, software or a combination thereof to facilitate an upgrade by processor 42 of software of manager 40, such as, for example, upgrades of the various protocols used by manager 40 and of newer versions of application and stack software. In one embodiment, on-air upgrader 46 includes a boot-loader.

Device controller(s) 47 is(are) structurally configured with hardware, software or a combination thereof to flexibly and/or dynamically control various parameters in profiles of nodes 50 and 70 (e.g., device information and application information). For example, a ballast profile of a single ballast within a node 50 can include a fade rate for dimming or maximum output level for maximum illumination. A device controller 47 can set these parameters and combine them in different ways to achieve desired levels of illumination.

System controller(s) 48 is(are) structurally configured with hardware, software or a combination thereof to flexibly and/or dynamically control various parameters in profiles of nodes 60 and 90 (e.g., device information and application information). For example, a ballast profile for each ballast within a node 60 can include a fade rate for dimming or maximum output level for maximum illumination. A system controller 48 can set these parameters and combine them in different ways to achieve desired levels of illumination.

Referring again to FIG. 1, wireless devices 50 include any type of device having a wireless control, including, but not limited to, a lighting fixture, a sensor of any type, a smoke/fire detector, a thermostat, and a window blind controller. To this end, each wireless device 50 includes a wireless interface 51 structurally configured to facilitate a wireless interfacing of its associated wireless device 50 with wireless network topology 30 (FIG. 1) in accordance with a wireless communication protocol (e.g., ZigBee).

Wireless systems 60 include any type of system having a wireless control, including, but not limited to, a lighting system having multiple lighting fixtures, a sensor system having multiple sensors, a smoke/fire detections system having multiple detectors, a temperature system having multiple thermostats, a window blind system and a HVAC system. To this end, each wireless system 60 includes a wireless interface 61 structurally configured to facilitate a wireless interfacing of its associated wireless system 60 with wireless network topology 30 (FIG. 1) in accordance with a wireless communication protocol (e.g., ZigBee).

Wireless devices 70 include any type of device having a wireless control, including, but not limited to, a lighting fixture, a sensor of any type, a smoke/fire detector, a thermostat, and a window blind controller. Each wireless device manager 80 is structurally configured with hardware, software and/or any combination thereof to directly manage a wireless device 70 in accordance with wireless network manager 40. In practice, the structural configuration of a wireless device manager 80 is dependent upon its commercial implementation. Therefore, the present invention does not impose any limitations or any restrictions as to the structural configuration of a wireless device manager 80 other than the ability to wirelessly interface with the other nodes of network 20 via wireless network topology 30. Thus, the following description of one embodiment of a wireless device manager 80 as illustrated in FIG. 3 does not limit or restrict the structural configuration of a wireless device manager 80.

Referring to FIG. 3, the illustrated embodiment of wireless device manager 80 includes a wireless interface 81, a processor 82, a commissioner/binder 83, a power consumption monitor 84, a diagnostic predictor 85, an on-air upgrader 86, and a device controller 87. Wireless interface 81 is structurally configured to facilitate a wireless interfacing of processor 82 with other nodes of network 20 via wireless network topology 30 (FIG. 1) in accordance with a wireless communication protocol (e.g., ZigBee). In one embodiment, wireless interface 81 is a wireless control device as will further described herein in connection with FIGS. 9 and 10.

Commissioner/binder 83 is structurally configured with hardware, software and any combination thereof to facilitate an implementation by processor 82 of a commissioning and binding of an associated wireless device 70 to network 20. For example, upon a physical installation of an associated wireless device 70 in a building or home, processor 82 implements commissioner/binder 83 to facilitate a joining of network 20 by the associated wireless device 70 and to facilitate a functional grouping of the associated wireless devices 70 as desired by wireless network manager 40.

Power consumption monitor 84 is structurally configured with hardware, software or a combination thereof to facilitate a power consumption management of an associated wireless device 70 and a transmission by processor 82 to wireless network manager 40 of information from the associated wireless device 70 related to power consumption measurements performed by the associated wireless device 70. This enables processor 82 and/or wireless network manager 40 to determine an overall energy consumption by the associated wireless device 70 whereby processor 82 can use an average power consumption breakdown by time of day, floor numbers or some other distinction that allows processor 82 and/or wireless network manager 40 to manage power consumption levels by the associated wireless device 70 in a manner directed to avoiding unnecessary energy consumption.

Diagnostic predictor 85 is structurally configured with hardware, software or a combination thereof to facilitate a determination of maintenance requirements of the associated wireless device 70, a prediction of end of life of the associated wireless device 70, and transmission by processor 82 to wireless network manager 40 of information from of the associated wireless device 70 related to its maintenance and predicted end of life. This enables processor 82 and/or wireless network manager 40 to provide an indication (e.g., an alarm) indicative of a maintenance parameter and/or an end of life prediction parameter being in nonconformance with certain criteria for such parameters.

On-air upgrader 86 is structurally configured with hardware, software or a combination thereof to facilitate an upgrade by processor 82 of software of wireless device manager 80, such as, for example, upgrades of the various protocols used by wireless device manager 80 and of newer versions of application and stack software. In one embodiment, on-air upgrader 86 includes a boot-loader.

Device controller 87 is structurally configured with hardware, software or a combination thereof to flexibly and/or dynamically control various parameters in a profiles of an associated wireless device 70 (e.g., device information and application information). For example, a ballast profile can include a fade rate for dimming or maximum output level for maximum illumination. A device controller 87 can set these parameters and combine them in different ways to achieve desired levels of illumination.

Wireless systems 90 include any type of system having a wireless control, including, but not limited to, a lighting system having multiple lighting fixtures, a sensor system having multiple sensors, a smoke/fire detections system having multiple detectors, a temperature system having multiple thermostats, a window blind system and a HVAC system. Wireless system manager 100 is structurally configured with hardware, software and/or any combination thereof to directly manage a plurality of wireless system(s) 90 in accordance with wireless network manager 40. In practice, the structural configuration of wireless system manager 100 is dependent upon its commercial implementation. Therefore, the present invention does not impose any limitations or any restrictions as to the structural configuration of wireless system manager 100 other than the ability to wirelessly interface with other nodes of network 20 via wireless network topology 30. Thus, the following description of one embodiment of wireless system manager 100 as illustrated in FIG. 4 does not limit or restrict the structural configuration of wireless system manager 100.

Referring to FIG. 4, the illustrated embodiment of wireless system manager 100 includes a wireless interface 101, a processor 102, a commissioner/binder 103, a power consumption monitor 104, a diagnostic predictor 105, an on-air upgrader 106, and a system controller 107. Wireless interface 101 is structurally configured to facilitate a wireless interfacing of processor 102 with other nodes of network 20 (FIG. 1) via wireless network topology 30 (FIG. 1) in accordance with a wireless communication protocol (e.g., ZigBee). In one embodiment, wireless interface 101 is a wireless lighting control system as will further described herein in connection with FIGS. 9 and 10.

Commissioner/binder 103 is structurally configured with hardware, software and any combination thereof to facilitate an implementation by processor 102 of a commissioning and binding of an associated wireless system 90 to network 20. For example, upon a physical installation of an associated system 90 in a building or home, processor 102 implements commissioner/binder 103 to facilitate a joining of network 20 by the associated wireless system 90 and to facilitate a functional grouping of the associated wireless systems 90 as desired by wireless network manager 40 (FIG. 1).

Power consumption monitor 104 is structurally configured with hardware, software or a combination thereof to facilitate a power consumption management of an associated wireless system 90 and a transmission by processor 102 to wireless network manager 40 of information from the associated wireless system 90 related to power consumption measurements performed by the associated wireless system 90. This enables processor 102 and/or wireless network manager 40 to determine an overall energy consumption by the associated wireless system 90 whereby processor 102 and/or wireless network manager 40 can use an average power consumption breakdown by time of day, floor numbers or some other distinction(s) that allows processor 102 and/or wireless network manager 40 to manage power consumption levels by an associated wireless system 90 in a manner directed to avoiding unnecessary energy consumption.

Diagnostic predictor 105 is structurally configured with hardware, software or a combination thereof to facilitate a determination of maintenance requirements of an associated wireless system 90, a prediction of end of life of the associated wireless system 90, and transmission by processor 102 to wireless network manager 40 of information from of the associated wireless system 90 related to its maintenance and predicted end of life. This enables processor 102 and/or wireless network manager 40 to provide an indication (e.g., an alarm) indicative of a maintenance and/or end of life prediction parameters being in nonconformance with certain criteria for such parameters.

On-air upgrader 106 is structurally configured with hardware, software or a combination thereof to facilitate an upgrade by processor 102 of software of wireless system manager 100, such as, for example, upgrades of the various protocols used by manager 100 and of newer versions of application and stack software. In one embodiment, on-air upgrader 106 includes a boot-loader.

System controller 107 is structurally configured with hardware, software or a combination thereof to flexibly and/or dynamically control various parameters in profiles of an associated wireless system 90 (e.g., system information and application information). For example, an illumination system profile can include a fade rate for dimming or maximum output level for maximum illumination. System controller 107 can set these parameters and combine them in different ways to achieve desired levels of illumination.

Referring to FIG. 1, each manager 80 is shown as being physically incorporated into associated device 70 and each manager 100 is shown as being physically incorporated into associated system 90. Alternatively, one or more of the managers 80 can be logically incorporated yet physically separated from an associated device 70 and one or more of the managers 90 can logically incorporated yet physically separated from an associated system 90.

FIG. 5 illustrates a digital ballast 120 of the present invention employing a power interface 121, a ballast controller 122 (e.g., a general purpose process, a digital signal processor, and an application specific integrated circuit) and a light source driver 123 (e.g., high speed inverter). Digital ballast 120 is connectable to a mains 110 and a light source 111 of any type (e.g., HID lamp(s), fluorescent lamp(s), LED lamp(s)) whereby ballast controller 122 controls and manages driver 123 in providing the proper voltage and/or current signals to light source 111.

Power interface 121 is connected to mains 110, ballast controller 122, and driver 123 for facilitating a determination of an average power consumption by ballast 120. In one embodiment, as illustrated in FIG. 6, a bridge B1 is connected to mains 110 (FIG. 5) via a pair of input terminal IN1 and IN2, and a pair of output terminals OUT1 and OUT2 are connected to driver 123. A resistor R1 is connected to bridge B1 and a non-inverting input (+) of op-amp U1. A pair of resistors R2 and R3 are connected in series between the non-inverting input (+) of op-amp U1 and an output of op-amp U1. An inverting input (−) of op-amp U1 is connected to ground. A pair of resistors R4 and R5 are connected in series between the output terminals OUT1 and OUT2 to serve as a voltage divider. Ballast controller 122 is connected to the voltage division of resistors R4 and R5 to sense a root mean square voltage V_{RMS} and connected to the output of op-amp U1 to sense a root mean square current I_{RMS} whereby ballast controller 122 is able to calculate an average power consumption P_{AVG} as a product of root mean square voltage V_{RMS} and root mean square current I_{RMS}, and the amount of energy consumed in any specific time duration by ballast 120.

Referring again to FIG. 5, to obtain an internal temperature reading, digital ballast 120 further internally includes a thermal sensor 124 within the ballast housing and in communication with ballast controller 122

Ballast controller 122 is further structurally configured to perform a predictive diagnosis of light source life time and ballast life time. FIG. 7 illustrates a flowchart 130 representative of a light source life time prediction method of the present invention. A stage S132 of flowchart 130 encompasses ballast controller 122 monitoring various light source life time factors, including, but not limited to, rated hours of the light source 111 (e.g., 20,000 hours for fluorescent lamps), running hours of light source 111, number of ignitions of light source 111, and DC voltage increases across light source 111.

A stage S134 of flowchart 130 encompasses ballast controller 122 calculating the remaining life of light source 111 based on the monitored factors. In one embodiment, the remaining life of light source 111 is calculated as being equal to (rated hours−run hours)*(starts derating)*(light source derating), where starts derating and light source derating are less than one. Both deratings change over the life time of light source 111. For fluorescent lamps, the starts derating will typically range from 1˜0.9 and the light source derating will typically range from 1˜0.01.

FIG. 8 illustrates a flowchart 140 representative of a ballast life time prediction method of the present invention. A stage S142 of flowchart 140 encompasses ballast controller 122 monitoring various ballast life time factors, including, but not limited to, number of attempts to strike digital light source 111, an internal temperature of digital ballast 120, a number of hours in standby for digital ballast 120, a number of hours in powering light source 111 by digital ballast 120 and total power-on hours of digital ballast 120.

A stage S144 of flowchart 140 encompasses ballast controller 122 calculating the remaining life of digital ballast 120 based on the monitored factors. An increase in the any of aforementioned factors decreases the life time of digital ballast 120. Thus, in one embodiment, the remaining life time of digital ballast 120 is calculated to reflect any increase in one or more of the monitored factors.

FIG. 9 illustrates a USB wireless control device 160 employing a USB connector 161, a USB to UART converter 162, a controller 163 and a RF transceiver 164. USB connector 161 is structurally configured to be plugged into a USB port 151 of a computer 150 of any type (e.g., a personal computer, a workstation, a personal data assistant, etc.) and RF transceiver 164 is structurally configured to modulate/demodulate RF signals for wireless communication with other nodes in a network (e.g., network 20 shown in FIG. 1). Controller 163 is structurally configured to implement communication stack processing on data and signal transfers between controller 163 and computer 150 and on data and signal transfers between controller 163 and other nodes of a corresponding network via RF transceiver 164. USB to UART converter 162 is structurally configured to appropriately format data and signal transfers between computer 150 and controller 163 in accordance with a USB standard.

In one embodiment particular suited for controlling a lighting device or system, device 160 is designed to work in a ZigBee wireless network with RF transceiver 164 being a RF transceiver EM2420 sold by Ember Corp., controller 163 being a ATmega128L sold by Atmel Corp, and USB to UART converter 162 being a FT232BM sold by FTDI LTd.

FIG. 10 illustrates a CF wireless control device 180 employing a CF connector 181, a CF to UART converter 182, a controller 183 and a RF transceiver 184. CF connector 181 is structurally configured to be plugged into a CF port 171 of a computer 170 of any type (e.g., a personal computer, a workstation, a personal data assistant, etc.) and RF transceiver 184 is structurally configured to modulate/demodulate RF signals for wireless communication with other nodes in a network (e.g., network 20 shown in FIG. 1). Controller 183 is structurally configured to implement communication stack processing on data and signal transfers between controller 183 and computer 170, and on data and signal transfers between controller 183 and other nodes of a corresponding network via RF transceiver 184. CF to UART converter 182 is structurally configured to appropriately convert data and signal transfers between computer 170 and controller 183 in accordance with a CF standard.

In one embodiment particular suited for controlling a lighting device or system, device 180 is designed to work in a ZigBee wireless network with RF transceiver 184 being a RF transceiver EM2420 sold by Ember Corp., controller 183 being a ATmega128L sold by Atmel Corp., and CF to UART converter 182 being a VPU16551 sold by Elan Digital Systems, Ltd.

Referring to FIGS. 1-10, those having ordinary skills in the art will appreciate numerous advantages of the present invention including, but not limited to, addressing the drawbacks of the background art previously described herein.

Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A wireless building and automation control network (20), comprising:
a wireless network topology (30);
a wireless network manager (40);
a wireless device (70); and
a wireless device manager (80) operable to be in wireless communication with the wireless network manager (40) in accordance with a communication protocol of the wireless network topology (30), and
wherein the wireless network manager (40) and the wireless device manager (80) are cooperatively operable to control an operating profile and to monitor an operational status of the wireless device (70).

2. The wireless building and automation control network (20) of claim 1, wherein the wireless network manager (40) and the wireless device manager (80) are further cooperatively operable to commission and bind the wireless device (70) to the wireless building and automation control network (20).

3. The wireless building and automation control network (20) of claim 1, wherein the wireless network manager (40) and the wireless device manager (80) are further cooperatively operable to monitor a power consumption by the wireless device (70).

4. The wireless building and automation control network (20) of claim 1, wherein the wireless network manager (40) and the wireless device manager (80) are further cooperatively operable to predicatively diagnosis an operational status of the wireless device (70).

5. The wireless building and automation control network (20) of claim 1, wherein the wireless network manager (40) and the wireless device manager (80) are further operable to perform an internal on-air upgrade.

6. A wireless building and automation control network (20), comprising:
a wireless network topology (30);
a wireless network manager (40);
a wireless system (90); and
a wireless system manager (100) operable to be in wireless communication with the wireless network manager (40) in accordance with a communication protocol of the wireless network topology (30),
wherein the wireless network manager (40) and the wireless system manager (100) are cooperatively operable to control an operating profile and to monitor an operational status of the wireless system (90).

7. The wireless building and automation control network (20) of claim 6, wherein the wireless network manager (40) and the wireless system manager (100) are further cooperatively operable to commission and bind the wireless system (90) to the wireless building and automation control network (20).

8. The wireless building and automation control network (20) of claim 6, wherein the wireless network manager (40) and the wireless system manager (100) are further cooperatively operable to monitor a power consumption by the wireless system (90).

9. The wireless building and automation control network (20) of claim 6, wherein the wireless network manager (40) and the wireless system manager (100) are further cooperatively operable to predicatively diagnosis an operational status of the wireless system (90).

10. The wireless building and automation control network (20) of claim 6, wherein the wireless network manager (40) and the wireless system manager (100) are further operable to perform an internal on-air upgrade.

11. A digital ballast (120), comprising:
a ballast controller (122); and
a power interface (121) operable electrically communicate a root means square voltage (V_{RMS}) and a roots means square current (I_{RMS}) to the ballast controller (122),
wherein the root means square voltage (V_{RMS}) and the roots means square current (I_{RMS}) are indicative of a power output of the power interface (121); and
wherein the ballast controller (122) is operable to determine an average power consumption of the digital ballast (120) as a product of the root means square voltage (V_{RMS}) and the roots means square current (I_{RMS}).

12. The digital ballast (120) of claim 11, wherein the power interface (121) includes means for generating the root means square voltage (V_{RMS}) and the roots means square current (I_{RMS}).

13. The digital ballast (120) of claim 11, wherein the ballast controller (122) is further operable to predict an operational life time of digital ballast (120).

14. The digital ballast (120) of claim 13, wherein a prediction of an operational life time of the digital ballast (120) is function of at least one of a number of attempts to strike a light source (111) being powered by digital ballast (120), an internal temperature of digital ballast (120), a number of standby hours for digital ballast (120), a number of hours of powering the light source (111) by digital ballast (120) and a total number of power-on hours of digital ballast (120).

15. The digital ballast (120) of claim 11, wherein the ballast controller (122) is further operable to predict an operational life time of a light source (111) being powered by digital ballast (120).

16. The digital ballast (120) of claim 14, wherein a prediction of an operational life time of the light source (111) is function of at least one of a number of run hours of the light source (111), a number of time the light source (111) has been started by the digital ballast (120), and any DC voltage increases across the light source (111).

17. A wireless control device (160, 180), comprising:
a controller (163, 183) operable to perform data and signal transfers with a computer (150, 170), and to perform data and signal transfers with a wireless network node;
a transceiver (164, 184) operable to establish a wireless communication between the controller (163, 183) and the wireless network node;
a port connector (161, 181) operable to plug the wireless control device (160, 180) into a port (151, 171) of a computer (150, 170); and
a data/signal converter (162, 182) operable to convert data and signal transfers between the controller (163, 183) and the computer (150, 170) via the port connector (161, 181) and the port (151, 171).

18. The wireless control device (160, 180) of claim 17,
wherein the port connector (161, 181) is a universal serial bus connectors; and
wherein the data/signal converter (162, 182) operates as a universal serial bus interface for the controller (163, 183).

19. The wireless control device (160, 180) of claim 17,
wherein the port connector (161, 181) is a compact flash connector; and
wherein the data/signal converter (162, 182) operates as a compact flash interface for the controller (163, 183).

20. The wireless control device (160, 180) of claim 17, wherein the transceiver (164, 184) is a radio frequency based transceiver.
